(19) United States
(12) Patent Application Publication
(10) Pub. No.: US 2007/0257522 A1
(43) Pub. Date: Nov. 8, 2007

(54) THREADED INSERTS IN STRUTS

(75) Inventors: Landon Ball, North Augusta, SC (US); Bradley J. Hanson, North Augusta, SC (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/381,925

(22) Filed: May 5, 2006

(51) Int. Cl. B60P 7/02; B60R 16/00

(52) U.S. Cl. 296/225; 296/100.17

(57) ABSTRACT

A strut assembly is provided including a first wall portion, a second wall portion, and a third wall portion. The first wall portion can have an outer surface. and an aperture therethrough. The second wall portion can be disposed generally opposite the first wall portion. The third wall portion can connect the first and second wall portions. The strut is provided with a threaded insert that can be configured to engage a fastener between the outer surface of the first wall portion and the second wall portion.

### FIELD

The present disclosure relates to golf cars and more specifically to struts for a golf car.

### BACKGROUND

The statements in this section merely provide background information related to the present disclosure and may not constitute prior art.

Golf cars provide transportation for golfers around a golf course. A golf car must also securely carry a golf bag in a location for convenient access throughout a round of golf. Many golf cars are equipped with a front windshield assembly that provides a transparent barrier to the passengers of the golf car. Many golf cars are also equipped with a roof canopy. In one arrangement, a front windshield assembly is attached between a pair of upwardly extending struts arranged on a front end of the golf car. The struts define a window frame and typically connect with the roof canopy of the golf car. A pair of upwardly extending struts may also be located at the rear of the golf car to provide support to the rear of the roof canopy. The attachment between the struts and the roof canopy typically includes a threaded bolt passing through the roof canopy and an upper portion of the strut. The bolt secures the roof canopy to the strut by engaging a nut located at the opposing side of the strut. This configuration results in a portion of the bolt and nut being visible from within the passenger compartment of the golf car.

### SUMMARY

According to the present disclosure, a strut assembly is provided with a first wall portion, a second wall portion, and a third wall portion. The first wall portion can have an outer surface. and an aperture therethrough. The second wall portion can be disposed generally opposite the first wall portion. The third wall portion can connect the first and second wall portions. A center portion can be disposed between the first wall portion and the second wall portion. The strut can be configured to engage a fastener between the outer surface of the first wall portion and the second wall portion.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present teachings in any way.

FIG. 1 is a perspective view of a golf car including the strut assembly of the present teachings;

FIG. 2 is a rear plan view of the golf car of FIG. 1;

FIG. 3 is a bottom plan view of the canopy and rear struts of the golf car of FIG. 1;

FIG. 4 is a sectional view of a connection between the canopy and a strut of the golf car taken along line 4-4 in FIG. 1;

FIG. 5 is a perspective view of a rivet nut; and

FIG. 6 is a perspective view of a weld nut.

### DETAILED DESCRIPTION OF THE VARIOUS EMBODIMENTS

The following description of various embodiments is merely exemplary in nature and is in no way intended to limit the present teachings, application, or uses.

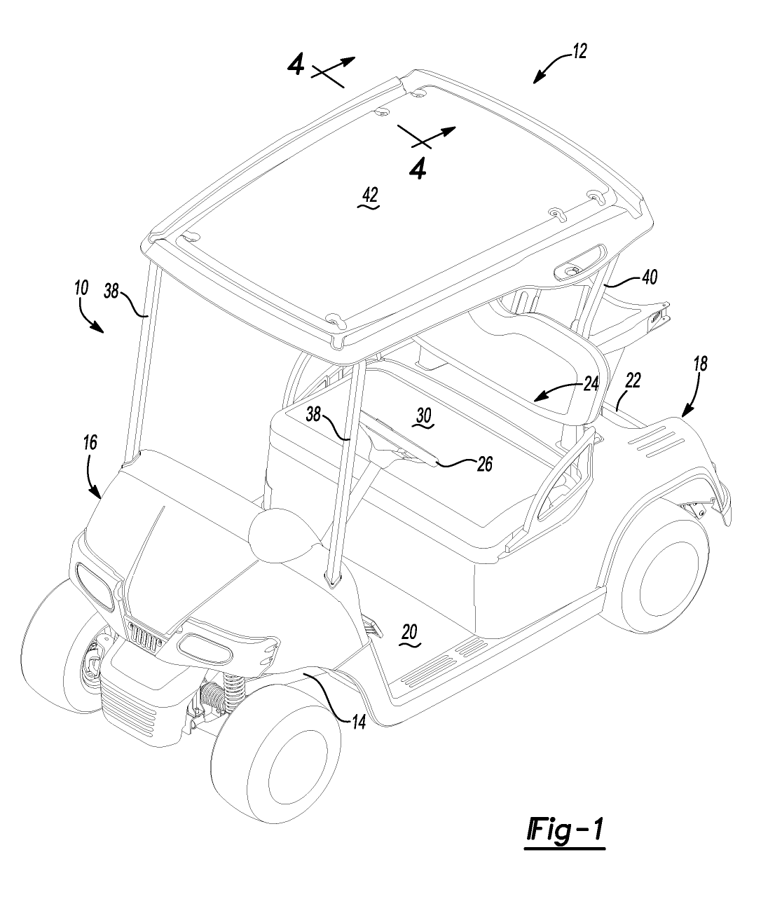

With initial reference to FIG. 1, a strut assembly constructed in accordance to the present disclosure is shown and identified generally at reference 10. The strut assembly 10 is illustrated operably connected to an exemplary golf car 12. It is appreciated that the golf car 12 is merely exemplary and that the strut assembly 10 can be adapted for use with other golf car configurations. Furthermore, the strut assembly 10 described herein is not limited for use with golf cars and can also be used with other vehicles such as, but not limited to, utility vehicles, lawnmowers, and other turf care vehicles.

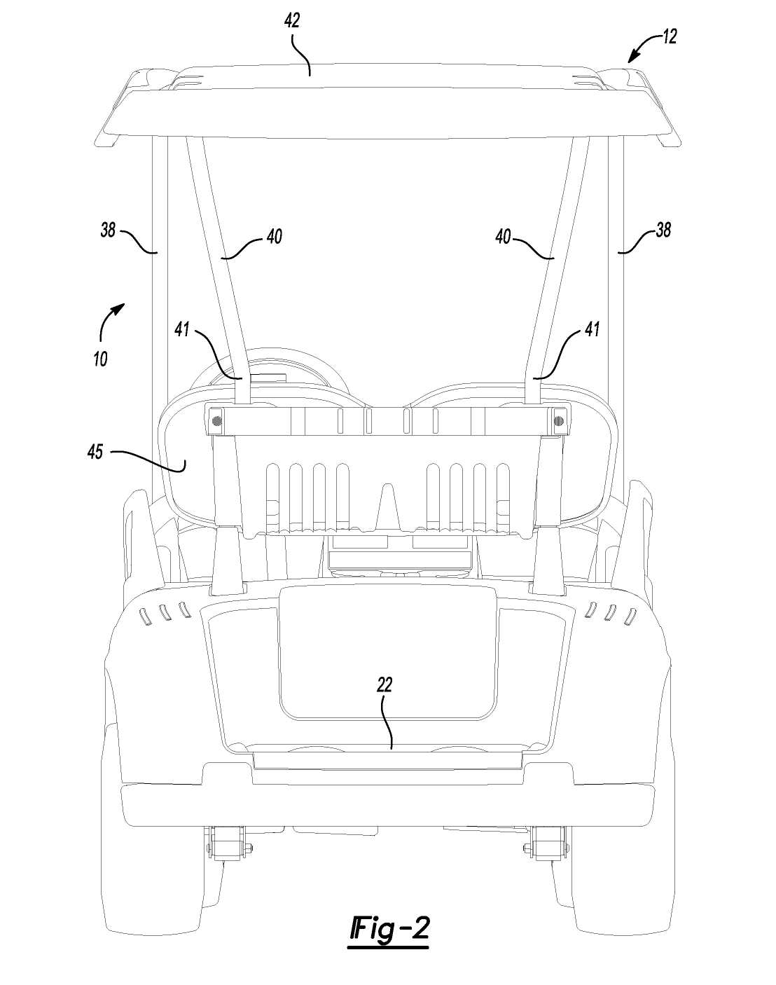

With additional reference to FIGS. 2-4, the golf car 12 can include a frame 14 having a front end 16 and a rear end 18 mounted thereon. The rear end 18 can include a golf bag storage area 22 and a passenger seating area 24. The passenger seating area 24 can include a steering wheel 26, accelerator and brake pedals (not shown), a seat 30, and a floor portion 20. The strut assembly 10 can include a pair of front struts 38 and a pair of rear struts 40 supporting a roof canopy 42.

The pair of front struts 38 can extend between the front end 16 of the golf car 12 and the roof canopy 42 and the pair of rear struts 40 can extend between the rear end 18 of the golf car 12 and the roof canopy 42. The front struts 38 can optionally support a windshield (not shown) therein. Alternatively, the golf car 12 can have no roof canopy 42 and struts 38 can be freestanding at an upper end. The struts 38 can also include a cross-member (not shown) connecting the upper ends.

The rear struts 40 can be coupled to a seat back support 45 at a first end 41. A second end 43 can be coupled to and support a rear portion of roof canopy 42. The rear struts 40 can be two separate members (as shown). Alternatively, rear struts 40 can include a cross-member (not shown) connecting second ends 43.

The strut assembly 10 can be coupled to another structure on the golf car 12. FIGS. 1-4 show the strut assembly 10 coupled to the roof canopy 42. It should be understood, however, that the present disclosure can be applied to any other appropriate mounting location on the golf car.

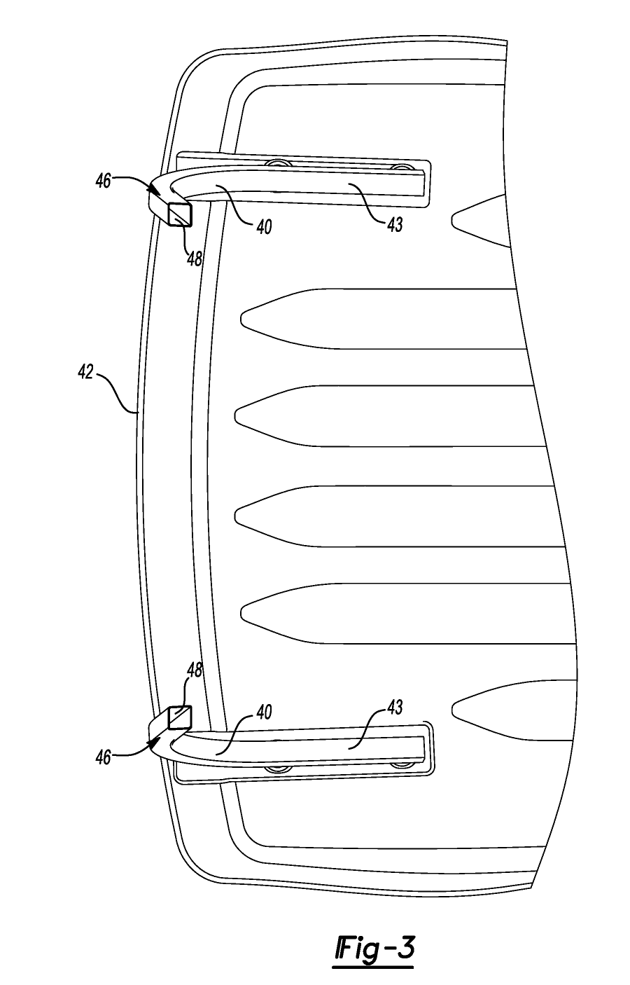

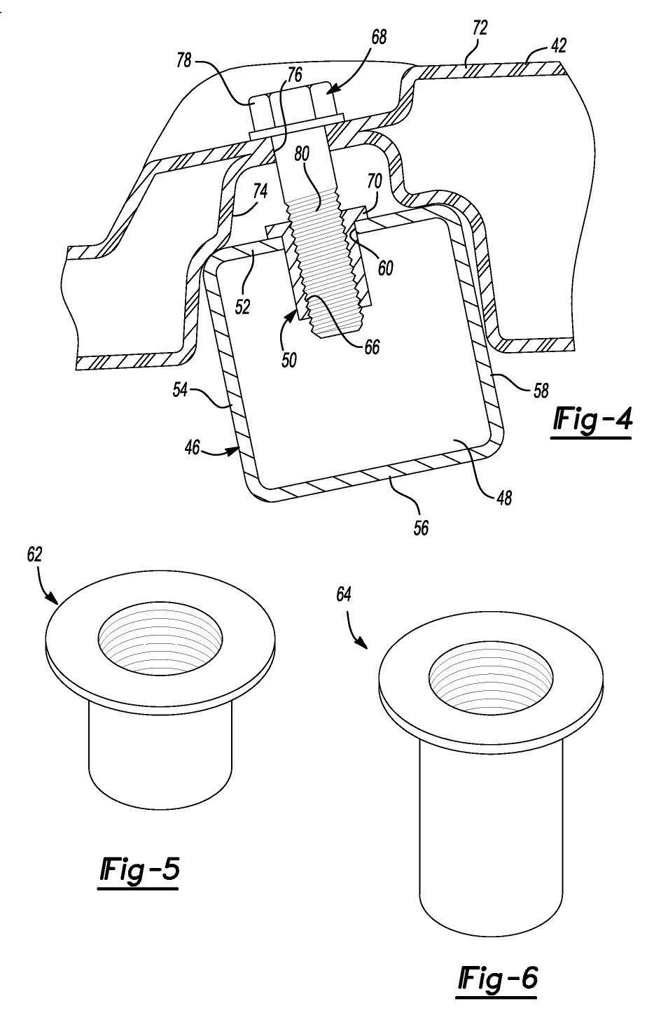

As previously noted, the strut assembly 10 can include front and rear struts 38, 40. While the present disclosure can be applied to both front and rear struts 38, 40, only rear strut 40 will be described for simplicity. As best shown in FIGS. 3 and 4, the rear strut 40 can have a body 46 defining a generally hollow center portion 48. A retaining member 50 can be non-rotatably coupled to the body 46 and extend into the generally hollow center portion 48, as shown in FIG. 4.

The body 46 of the rear strut 40 can have a generally rectangular cross-section, providing four (4) sides 52, 54, 56, 58 of the rear strut 40. An aperture 60 can be located in the upper side 52 of rear strut 40. The remaining sides 54, 56, 58 can be generally solid. Alternatively, the strut 40 can have a circular or oval cross-section which still generally has four sides.

The retaining member 50 can be located within aperture 60. A variety of different retaining members can be used. For example, the retaining member 50 could be a weld nut 62 or a rivet nut 64 (shown in FIGS. 5 and 6, respectively). As such, the retaining member 50 can be retained within aperture 60 in a variety of ways, depending on the type of retaining member 50 used. For example, the retaining member 50 can be coupled to the strut 40 by a welded engagement (weld nut 62) or by an interference fit (rivet nut 64).

The interior portion 66 of the retaining member 50 can have a threading for engagement with a bolt 68. The retaining member 50 can also include an upper flange portion 70 that generally abuts an exterior surface of side 52. The upper flange portion 70 can serve as a welding point or as a travel limiter (where there is an interference fit engagement).

The roof canopy 42 can include an upper surface 72 and a lower surface 74. The lower surface 74 can generally abut strut upper side 52, be slightly offset from strut upper side 52, or a combination thereof as seen in FIG. 4. An aperture 76 can be located in the roof canopy 42 and extend through the upper and lower surfaces 72, 74. The aperture can generally be in alignment with retaining member 50.

The bolt 68 can include a head 78 and a threaded shank 80. The head 78 can generally abut upper surface 72 above aperture 76. The shank 80 can extend through aperture 76 and engage interior portion 66 of retaining member 50, coupling roof canopy 42 to rear strut 40. The shank 80 can terminate within generally hollow center portion 48. Generally solid side 56 can therefore conceal bolt 68 from within passenger seating area 24 of golf car 12 (as shown in FIG. 3).

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A strut comprising:
a first wall portion having an outer surface, said first wall portion having an aperture therethrough;
a second wall portion opposite said first wall portion;
a third wall portion connecting said first and second wall portions; and
an insert disposed in said aperture in said first wall portion and including a threaded portion.

2. The strut of claim 1, wherein said insert includes a flange portion and a body portion generally extending from said flange portion, said flange portion having a diameter greater than a diameter of said body portion, said flange portion generally abutting said outer surface of said first wall portion and said body portion generally extending into said aperture.

3. The strut of claim 2, wherein a majority of said body portion extends into said aperture and between said first and second walls.

4. The strut of claim 2, wherein said insert is captured within said aperture through an interference engagement.

5. The strut of claim 4, wherein said insert is a rivet nut.

6. The strut of claim 2, wherein said insert is retained within said aperture through a welded engagement between said flange portion and said first wall portion.

7. The strut of claim 6, wherein said insert is a weld nut.

8. The strut of claim 1, wherein said second wall portion comprises a generally continuous wall.

9. The strut of claim 1, wherein said strut is a golf car strut adapted to support a canopy roof of a golf car.

10. A strut comprising:
a hollow tubular body including first wall portion having an aperture therethrough; and
an insert captured within said aperture, said insert having a threaded inner surface configured for engaging a fastener therein.

11. The strut of claim 10, wherein said insert includes a flange portion and a body portion generally extending from said flange portion, said flange portion having a diameter greater than a diameter of said body portion, said flange portion generally abutting an outer surface of said first wall portion and said body portion generally extending into said aperture.

12. The strut of claim 11, wherein said insert is captured within said aperture through an interference engagement.

13. The strut of claim 12, wherein said insert is a rivet nut.

14. The strut of claim 11, wherein said insert is retained within said aperture through a welded engagement between said flange portion and said first wall portion.

15. The strut of claim 14, wherein said insert is a weld nut.

16. The strut of claim 10, wherein said strut is a golf car strut adapted to support a canopy roof of a golf car.

17. A vehicle comprising:
a strut including a first wall portion having an outer surface, said first wall portion having an aperture therethrough, a second wall portion opposite said first wall portion, said first and second wall portions connected to one another by a third wall portion, and an insert disposed in said aperture in said first wall portion and including a threaded portion disposed between said first wall portion and said second wall portion;
a body member having an aperture therethrough, said aperture in said body member generally aligned with said aperture in said strut; and
a fastener passing through said apertures in said strut and said body member, a first end of said fastener engaging said insert at a location between said body member and said second wall portion.

18. The vehicle of claim 17, wherein said insert includes a flange portion and a body portion generally extending from said flange portion, said flange portion having a diameter greater than a diameter of said body portion, said flange portion generally abutting said outer surface of said first wall portion and said body portion generally extending into said aperture.

19. The vehicle of claim 18, wherein said insert is a rivet nut.

20. The vehicle of claim 18, wherein said insert is a weld nut.

21. The vehicle of claim 17, wherein said body member is a roof canopy.

22. The vehicle of claim 17, wherein said vehicle is a golf car.
